(19) United States
(12) Patent Application Publication
(10) Pub. No.: US 2012/0091926 A1
(43) Pub. Date: Apr. 19, 2012

(54) ELECTRONIC SPEED CONTROLLER APPARATUS WITH SIGNAL DIVIDING PORT DEVICE AND CONTROL METHOD THEREOF

(76) Inventor: Chih-Yuan SHEN, New Taipei City (TW)

(21) Appl. No.: 13/220,036

(22) Filed: Aug. 29, 2011

Related U.S. Application Data
(60) Provisional application No. 61/394,356, filed on Oct. 19, 2010.

(51) Int. Cl. G05D 13/02

(52) U.S. Cl. 318/16

(57) ABSTRACT

The present invention discloses an electronic speed controller apparatus with a signal dividing port device and a control method thereof. An electronic speed controller apparatus comprises an electronic speed controller, a radio receiver, and a signal dividing port device. The radio receiver is electronically connected with the electronic speed controller. The signal dividing port device is electronically connected with the electronic speed controller. The signal dividing port device has at least one port. In the present invention, the radio receiver receives signals from a signal emitting station and transmits the signals to the electronic speed controller, the signal dividing port device integrates power button, light emitting module and at least one port to further electrically connection with a programming adapter or a terminal.

### FIELD OF THE INVENTION

The present application claims the benefit of U.S. Provisional Application Ser. No. 61/394,356 filed on Oct. 19, 2010, the subject matter of which is hereby incorporated by reference.

The present invention is related to an electronic speed controller apparatus with a signal dividing port device and a control method thereof, and particularly to an electronic speed controller apparatus that is able to extend its function without interrupting the function of other parts.

### BACKGROUND OF THE INVENTION

An electronic speed controller (ESC) for a DC motor is an electronic circuit with the purpose to vary an electric motor's speed, its direction and possibly also to act as a dynamic brake. The electronic speed controller is often used on an electrically-powered radio controlled model, and it can be a stand-alone unit or incorporated into the receiver itself. Typically, it includes a microprocessor with a memory or firmware. Most electronic speed controllers are preprogrammed at the manufacturer for a particular application and with a fixed set of instructions or functions. These electronic speed controllers typically have no means for re-programming the memory. Other electronic speed controllers may include programmable memory such as EEPROM or flash memory and a dedicated programming port to enable updating of the software functions or to fix program bugs.

In order to introduce the brief idea of a conventional electronic speed controller apparatus, please refer to FIG. 1 and FIG. 2, which are a functional diagram illustrating the conventional electronic speed controller apparatus combined with a radio receiver and a functional diagram illustrating the conventional electronic speed controller apparatus combined with a programming adapter.

The conventional electronic speed controller apparatus comprises an electronic speed controller 1′, a radio receiver 2′, and a programming adapter 3′. The electronic speed controller 1′ includes a port 11′ which is used for electrical connection with different kinds of connectors. In both FIG. 1 and FIG. 2, the electronic speed controller 1′ is connected with battery 4′ and the motor 5′ (the structures of which have not been shown). The electronic speed controller 1′ not only controls the speed of the motor 5′ but also control the power of the energy transferred from the battery 4′ to the motor 5′. The difference between FIG. 1 and FIG. 2 is that the electronic speed controller 1′ is separately connected with the radio receiver 2′ and the programming adapter 3′.

In the FIG. 1, the radio receiver 2′ includes a first connector 21′ and an antenna 22′. The first connector 21′ is used for connecting electronic speed controller 1′ with the radio receiver 2′. The first connector 21′ is connected with the port 11′ of the electronic speed controller 1′. The antenna 22′ of the radio receiver 2′ is used for receiving signals from other signal emitting station, for example, a remote control transmitter. In the FIG. 2, the programming adapter 3′ includes a second connector 31′ connected with the port 11′ of the electronic speed controller 1′. Actually, the programming adapter 3′ is acted as a bridge between the electronic speed controller 1′ and a computer 6′, such that user is able to adjust parameters of the electronic speed controller 1′ by computer applications 6′.

However, it may be recognizable that, in FIG. 1 and FIG. 2, the number of port 11′ of the electronic speed controller 1′ is only one, and the user may only use the port 11′ to connect the radio receiver 2′ and the programming adapter 3′ separately. In other words, the radio receiver 2′ and the programming adapter 3′ cannot be connected with the electronic speed controller 1′ at the same time. It can be inferred that when the user adjusts parameters of the electronic speed controller 1′, the radio receiver 2′ is temperately out of use. If it is necessary for the user to adjust parameters of the electronic speed controller 1′ and it is essential for the radio receiver 2′ receiving importing order/command from a remote controller, the conventional electronic speed controller apparatus may not satisfy the basic needs of operation. Besides, some ports 11′ of the conventional electronic speed controller apparatus may not be easily exposed outside of a vehicle because demand of water-proofing. It may not be convenient for user to frequently unplug the first connector 21′ or the second connector 31′.

In order to solve this problem, it is necessary to contemplate a mechanism that is convenient for a user to adjust parameters of the electronic speed controller but the radio receiver can receive the signal at the same time. One of the innovative functions the present invention can provide is to solve that problem.

### SUMMARY OF THE INVENTION

The present invention discloses an electronic speed controller apparatus with signal dividing port device and control method thereof. An electronic speed controller apparatus comprises an electronic speed controller, a radio receiver, and a signal dividing port device. The radio receiver is electronically connected with the electronic speed controller. The signal dividing port device is electronically connected with the electronic speed controller. The signal dividing port device has at least one port. In the present invention, the radio receiver receives signals from a signal emitting station and transmits the signals to the electronic speed controller. At least one port of the signal dividing port device is further electrically connected with a programming adapter or a terminal.

The present invention discloses a control method of an electronic speed controller apparatus, comprising the following steps: providing an electronic speed controller; providing a radio receiver connected with the electronic speed controller and; providing a signal dividing port device electronically connected with the electronic speed controller, and the signal dividing port device having at least one port; and wherein the radio receiver receives signals from a signal emitting station and transmits the signals to the electronic speed controller; wherein the at least one port of the signal dividing port device is further electrically connected with a programming adapter or a terminal.

By this manner, the connection between the radio receiver and the electronic speed controller and the connection between the signal dividing port device and the electronic speed controller are mutually independent from each other.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more clearly from the detailed description given below and from the accompanying drawings of various embodiments of the invention, which, however, should not be taken to limit the invention to the specific embodiments, but are for explanation and understanding only.

FIG. 1 is a functional diagram illustrating the conventional electronic speed controller apparatus connected to a radio receiver;

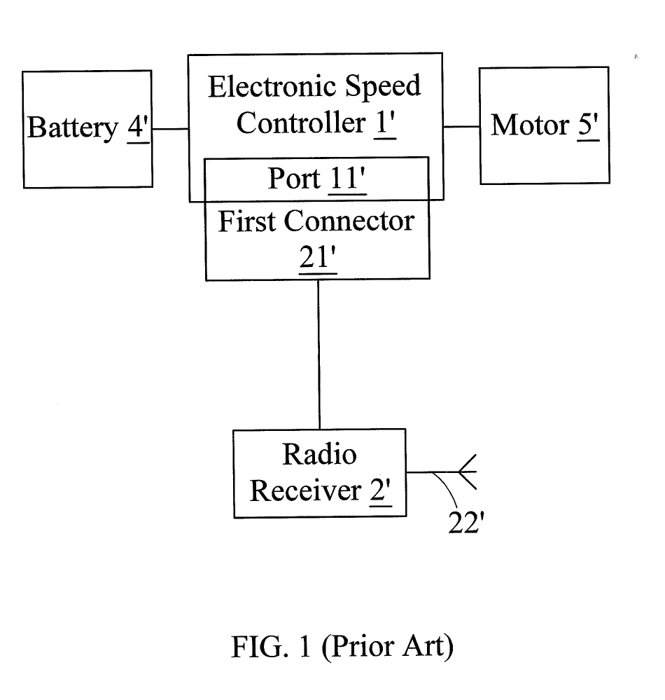

FIG. 2 is a functional diagram illustrating the conventional electronic speed controller apparatus connected to a computer by using a programming adapter;

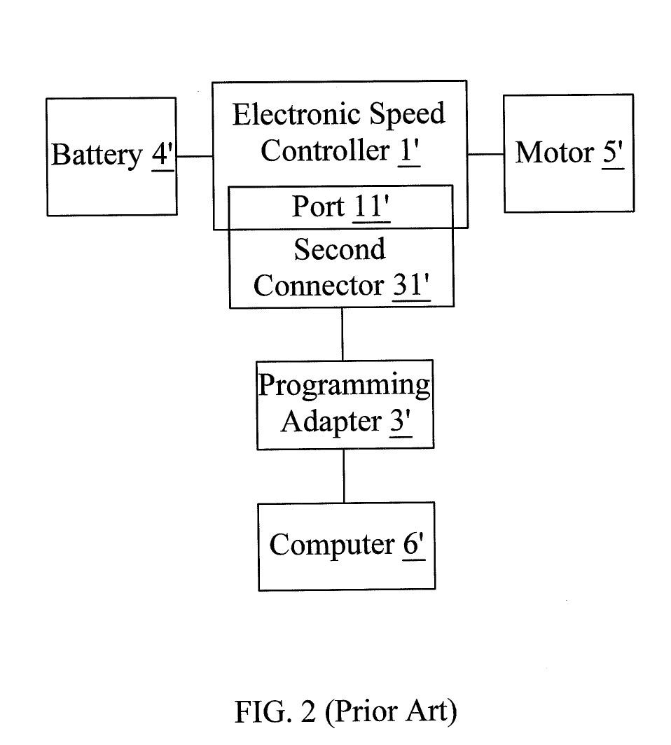

FIG. 3 is a schematic view illustrating a structure of a signal dividing port device according to the present invention;

FIG. 4 is a functional diagram illustrating the electronic speed controller apparatus combined of a first embodiment according to the present invention;

FIG. 5 is a functional diagram illustrating the electronic speed controller apparatus combined of a second embodiment according to the present invention;

FIG. 6 is a schematic view illustrating a structure of the speed controller apparatus according to the present invention; and

FIG. 7 is a flowchart illustrating a control method of an electronic speed controller apparatus according to the present invention.

### DETAILED DESCRIPTION OF THE PREFERRED EMBODIMENTS

Exemplary embodiments of the present invention are described herein in the context of electronic speed controller apparatus with signal dividing port device and control method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

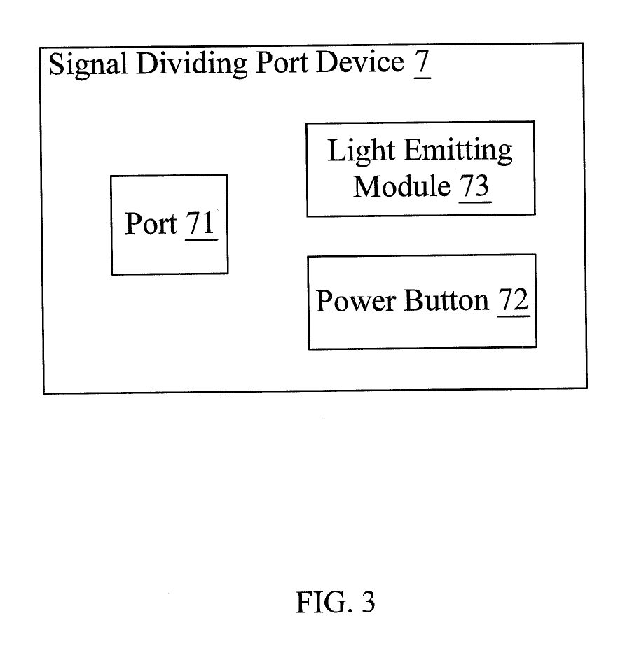

Please refer to FIG. 3, which is a schematic view illustrating a structure of signal dividing port device according to the present invention. A signal dividing port device 7 includes a port 71, a power button 72, and a light emitting module 73. The power button 72 is able to turn on or turn off the function of the electronic speed controller 1. The light emitting module 73 is used for indicating the operation mode of ESC. The light emitting module 73 in the present invention includes at least one light emitting diode (LED) for indication, but in the actual practice, the number of the LED is not limited and other light emitting element, such as bulbs, may be chosen to replace LED. The light emitting module 73 may be a plurality of LEDs, which show different colors, to represent the condition as follows: (1) the vehicle accelerating or decelerating; (2) the vehicle moving forward or backward; (3) the power of the battery; or (4) whether the electronic speed controller receiving the signal from the antenna.

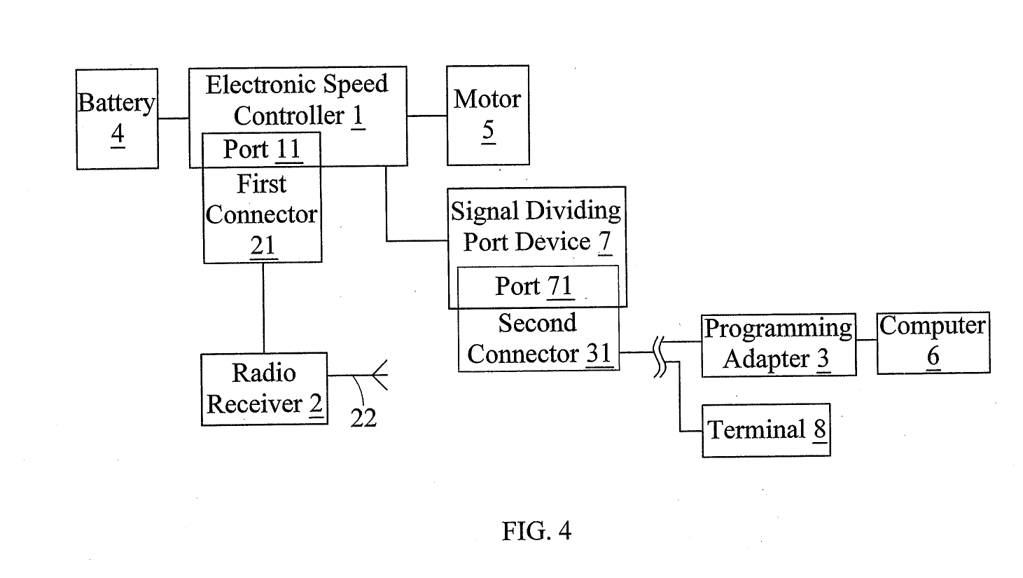

Please refer to FIG. 4, which is a functional diagram illustrating the electronic speed controller apparatus combined of the first embodiment according to the present invention. The electronic speed controller apparatus comprises an electronic speed controller 1, a radio receiver 2, and a signal dividing port device 7. The electronic speed controller 1 includes a port 11 which is used for electrical connection with the radio receiver 2. In FIG. 4, the electronic speed controller 1 is electrically connected with a battery 4 and a motor 5 (the structures of which have not been shown). The electronic speed controller 1 not only controls the speed of the motor 5 but also control the power of the energy transferred from the battery 4 to the motor 5.

In the FIG. 4, the radio receiver 2 includes a first connector 21 and an antenna 22. The first connector 21 is used for connecting electronic speed controller 1 with the radio receiver 2. The first connector 21 is connected with the port 11 of the electronic speed controller 1. The antenna 22 of the radio receiver 2 is used for receiving signals from other signal emitting station (for example, from a remote control transmitter).

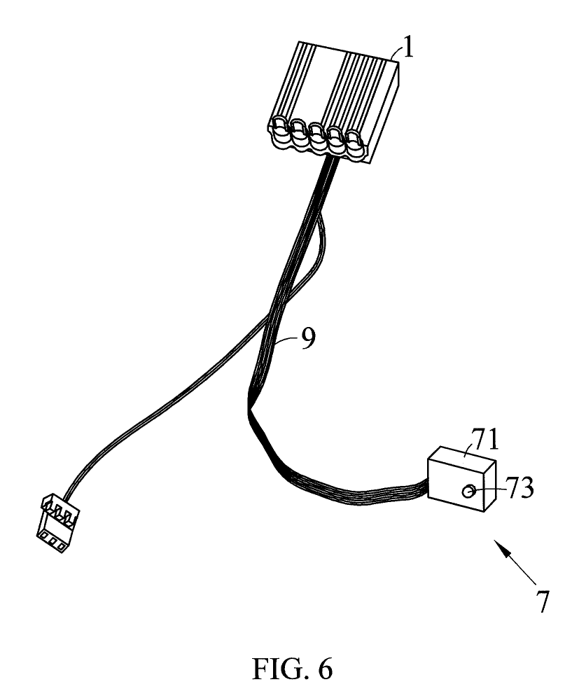

Unlike conventional electronic speed controller apparatus, which programming adapter 3′ connected with the port 11′ of the electronic speed controller 1′, a programming adapter 3 of the present invention is connected with the signal dividing port device 7. As mentioned before, the signal dividing port device 7 includes the at least one port 71, the power button 72, and the light emitting module 73. The electronic speed controller 1 electrically connected with the signal dividing port device 7. The way the electronic speed controller 1 connected with the signal dividing port device 7 is not limited. For instance, please refer to FIG. 6, which is a schematic view illustrating a structure of the speed controller apparatus according to the present invention. A connecting wire 9 might connect the electronic speed controller 1 and the port 71 of the signal dividing port device 7. The two ends of the connecting wire 9 can be fixed or selectively plugged or in combination on the electronic speed controller 1 and the signal dividing port device 71.

By means of the at least one port 71 of the signal dividing port device 7, the signal dividing port device 7 is able to be further electrically connected with the programming adapter 3. The programming adapter 3 is electrically connected with the signal dividing port device 7 by using a connecting wire, one end of which is a second connector 31 connected with the port 71 of the signal dividing port device 7. As mentioned before, the programming adapter 3 is acted as a bridge between the electronic speed controller 1 and a computer 6, since the signal characteristics used by the electronic speed controller 1 and the computer are different, such that user is able to adjust parameters of the electronic speed controller 1 on the interface provided by the computer 6. In the present invention, the signal dividing port device 7 provides connection between the electronic speed controller 1 and the programming adapter 3. Therefore the connection between the radio receiver 2 and the electronic speed controller 1 and the connection between the signal dividing port device 7 and the electronic speed controller 1 are mutually independent from each other. That is, user may adjust parameters of the electronic speed controller 1 through the programming adapter 3 and the signal dividing port device 7 without unplugging the first connector 21 of the radio receiver 2. The electronic speed controller 1 is able to receive signals from the radio receiver and at the same time parameters of the electronic speed controller 1 are adjustable. In addition, this feature will be convenient for user when the first connector 21 is connected with the port 11 which is disposed at the place of the electronic speed controller 1 that is uneasy to unplug. Besides, it is also practical that the electronic speed controller 1 and the radio receiver 2 are electronically connected with a signaling wire.

Moreover, the signal dividing port device 7 is able to be connected with a terminal 8. In the FIG. 3 and FIG. 4, there is only one port 71 of the signal dividing port device 7. It is shown that the second connector 31 of the programming adapter 3 is connected with the port 71 of the signal dividing port device 7. The port 71 is able to be connected with a third connector (not shown) of the terminal 8. The user can unplug the second connector 31 and plug the third connector to the port 71 of the signal dividing port device 7. In addition, it is applicable that the number of the port 71 can be two or even more, such that it is not necessary to unplug the second connector 3 of the programming adapter 3 plug the third connector of the terminal 8. Those connectors can plug into the plurality of the ports 71. The terminal 8 in the present invention functions as a combination between a programming adapter and a simplified computer. The terminal 8 can includes a small monitor and a plurality of buttons (not shown). Those buttons can be arranged on the case of the terminal 8 or can be visual buttons on the small monitor. User is able to directly adjust parameters of the electronic speed controller 1 through the terminal 8 without using an additional adapter.

Meanwhile, the signal dividing port device 7 can be independently used. For example, when the signal dividing port device 7 is not connecting the programming adapter 3 or the terminal 8, the signal dividing port device 7 is still be able to indicate the status of the electronic speed controller by the light emitting module 73 just mentioned before.

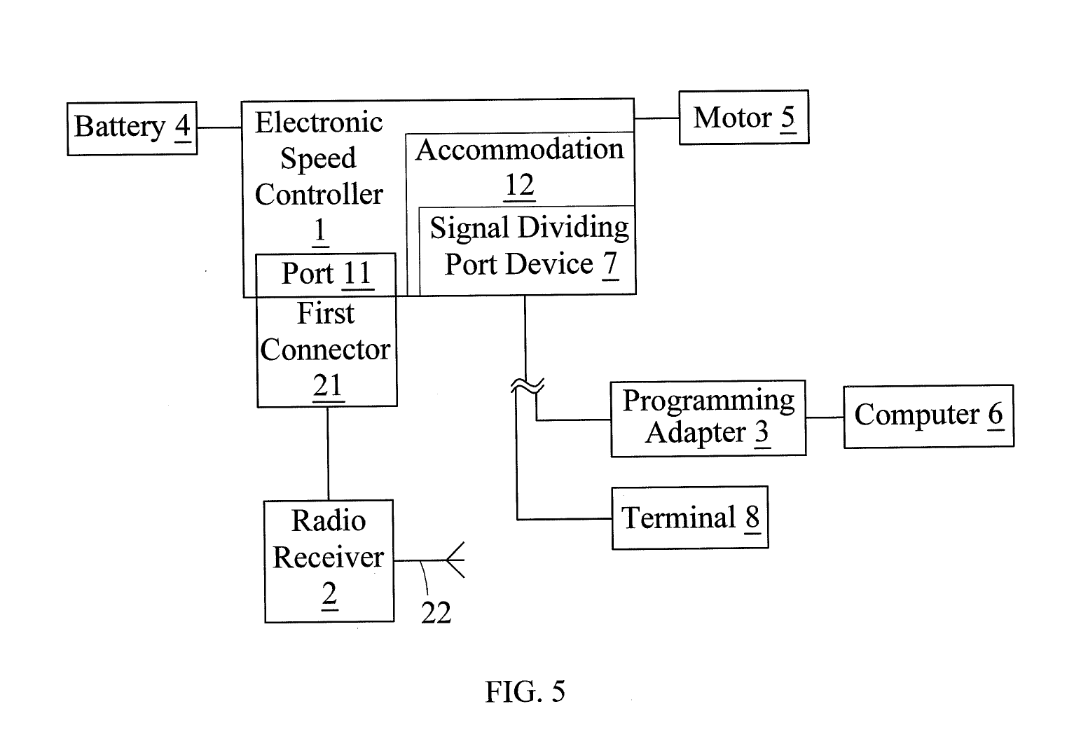

The signal dividing port device 7 is able to be externally disposed with the electronic speed controller 1, just as the first embodiment. However, the signal dividing port device 7 is able to be internally attached on the electronic speed controller 1. Please refer to FIG. 5, which is a functional diagram illustrating the electronic speed controller apparatus combined of the second embodiment according to the present invention. The radio receiver 2, the programming adapter 3, the battery 4, the motor 5, the computer 6, and the terminal 8 may be the similar features mentioned in the first embodiment. However, it is applicable that the signal dividing port device 7 is able to be internally attached with electronic speed controller 1.

In the second embodiment of the present invention, the electronic speed controller 1 of the electronic speed controller apparatus further includes an accommodation 12. The signal dividing port device 7 is disposed in the accommodation 12, such that a connecting wire connecting the electronic speed controller 1 and the programming adapter 3 may not necessarily be used. The integration of the electronic speed controller 1 and the signal dividing port device 7 may lead the overall structure to be more simplified, especially when the signal dividing port device 7 is accommodated into the accommodation 12. Of course, it is applicable that the signal dividing port device 7 is just disposed/attached on the surface (not shown) of the electronic speed controller 1. The relative positions between signal dividing port device 7 and the electronic speed controller 1 will not limit the scope of the present invention.

In summary, the electronic speed controller apparatus includes a signal dividing port device which can work independently from the radio receiver. The parameters of the electronic speed controller can be adjusted by the computer and at the same time the function of the radio receiver will not be interrupted.

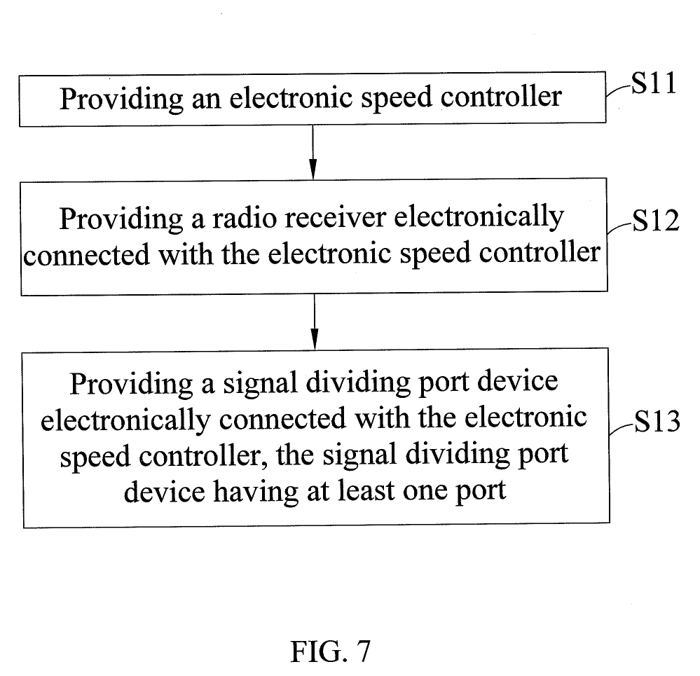

Please refer to FIG. 7. Based on the electronic speed controller apparatus mentioned above, the present invention further discloses a control method of an electronic speed controller apparatus comprising the following step:

Step 11: providing an electronic speed controller;

Step 12: providing a radio receiver electronically connected with the electronic speed controller; and

Step 13: providing a signal dividing port device electronically connected with the electronic speed controller, the signal dividing port device having at least one port.

In the steps mentioned above, the radio receiver receives signals from a signal emitting station and transmits the signals to the electronic speed controller. At least one port of the signal dividing port device is further electrically connected with a programming adapter or a terminal. The electronic speed controller receives signal from a signal emitting station and at the same time the parameters of the electronic speed controller are adjustable.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An electronic speed controller apparatus, comprising:
an electronic speed controller;
a radio receiver electronically connected with the electronic speed controller; and
a signal dividing port device electronically connected with the electronic speed controller, and the signal dividing port device having at least one port;
wherein the radio receiver receives signals from a signal emitting station and transmits the signals to the electronic speed controller;
wherein the at least one port of the signal dividing port device is further electrically connected with a programming adapter or a terminal.

2. The electronic speed controller apparatus as claimed in claim 1, wherein the at least one port of the signal dividing port device is connected with the programming adapter, and the programming adapter is further electrically connected with a computer such that parameters of the electronic speed controller are able to be adjusted by computer application.

3. The electronic speed controller apparatus as claimed in claim 2, wherein the electronic speed controller receives the signals from the signal emitting station by the radio receiver and at the same time the parameters of the electronic speed controller are adjustable.

4. The electronic speed controller apparatus as claimed in claim 1, wherein a connection between the radio receiver and the electronic speed controller and a connection between the signal dividing port device and the electronic speed controller are mutually independent from each other.

5. The electronic speed controller apparatus as claimed in claim 1, wherein when the terminal is working, the electronic speed controller is able to receive the signals from the radio receiver at the same time.

6. The electronic speed controller apparatus as claimed in claim 1, wherein the electronic speed controller includes a port and the radio receiver includes a first connector connected with the port of the electronic speed controller.

7. The electronic speed controller apparatus as claimed in claim 1, wherein the signal dividing port device includes a power button to turn on or turn off a function of the electronic speed controller.

8. The electronic speed controller apparatus as claimed in claim 1, wherein the signal dividing port device includes a light emitting module used for indicating current status of the electronic speed controller.

9. The electronic speed controller apparatus as claimed in claim 8, wherein the light emitting module comprises at least one light emitting diode.

10. The electronic speed controller apparatus as claimed in claim 1, the signal dividing port device includes at least one port.

11. The electronic speed controller apparatus as claimed in claim 10, further comprising a connecting wire, one end of which having a second connector connected with the at least one port of the signal dividing port device.

12. The electronic speed controller apparatus as claimed in claim 1, wherein the signal dividing port device is externally disposed with the electronic speed controller.

13. The electronic speed controller apparatus as claimed in claim 1, wherein the signal dividing port device is internally attached with the electronic speed controller.

14. The electronic speed controller apparatus as claimed in claim 13, wherein the electronic speed controller apparatus further includes an accommodation, and the signal dividing port device is disposed in the accommodation.

15. The electronic speed controller apparatus as claimed in claim 1, wherein the signal dividing port device is attached on the surface of the electronic speed controller.

16. The electronic speed controller apparatus as claimed in claim 1, wherein the electronic speed controller is electrically connected with a battery and a motor.

17. A control method of an electronic speed controller apparatus, comprising following steps:
providing an electronic speed controller;
providing a radio receiver electronically connected with the electronic speed controller; and
providing a signal dividing port device electronically connected with the electronic speed controller, and the signal dividing port device having at least one port; and
wherein the radio receiver receives signals from a signal emitting station and transmits the signals to the electronic speed controller;
wherein the at least one port of the signal dividing port device is further electrically connected with a programming adapter or a terminal.

18. The control method of an electronic speed controller apparatus as claimed in claim 17, wherein the at least one port of the signal dividing port device is connected with the programming adapter, and the programming adapter is further electrically connected with a computer such that parameters of the electronic speed controller are able to be adjusted by computer application.
